(19) United States
(12) Patent Application Publication
(10) Pub. No.: US 2026/0067673 A1
(43) Pub. Date: Mar. 5, 2026

(54) NEIGHBOR DISCOVERY MECHANISMS FOR PROTECTED BASIC SERVICE SETS (BSSs)

(71) Applicant: Cisco Technology, Inc., San Jose, CA (US)

(72) Inventors: Jerome HENRY, Pittsboro, NC (US); Robert E. BARTON, Richmond (CA); Malcolm M. SMITH, Richardson, TX (US); Domenico FICARA, Essertines-Sur-Yverdon (CH); Ugo M. CAMPIGLIO, Morges (CH); Javier I. CONTRERAS ALBESA, Sant Cugat del Valles (ES)

(21) Appl. No.: 19/281,613

(22) Filed: Jul. 26, 2025

Related U.S. Application Data
(60) Provisional application No. 63/690,978, filed on Sep. 5, 2024.

(51) Int. Cl. H04W 8/26; H04W 24/10

(52) U.S. Cl. CPC H04W 8/26; H04W 24/10

(57) ABSTRACT

An AP may provide information about a neighbor AP to a STA before roaming to assist with the STA associating with the neighbor AP. The information may include a BSSID of the neighbor AP and a time until the neighbor AP rotates the BSSID. If the STA fails to discover the neighbor AP while the STA is roaming, the STA can request more information about the neighbor AP from the AP.

### CROSS-REFERENCE TO RELATED APPLICATIONS

This application claims benefit of co-pending U.S. provisional patent application Ser. No. 63/690,978 filed Sep. 5, 2024. The aforementioned related patent application is herein incorporated by reference in its entirety.

### TECHNICAL FIELD

Embodiments presented in this disclosure generally relate to discovery of parameters for an access point (AP). More specifically, embodiments disclosed herein relate to an AP that monitors changes in a Basic Service Set Identifier (BSSID) of another AP.

### BACKGROUND

An access point (AP) is a device that allows a station (STA) to connect to a network by the STA associating with the AP. An AP may hide parameters such as a Service Set Identifier (SSID) or Basic Service Set Identifier (BSSID) to prevent malicious devices or users from mimicking the AP. However, when hiding parameters, other APs and STAs may encounter difficulty discovering the AP. As a result, the STAs may not discover the AP when the STAs are roaming and looking to join an AP in a network.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a diagram of an example operation of a first AP providing a report to a STA about a second AP, according to one embodiment.

FIG. 2 depicts a flowchart of an exemplary method for a first AP providing a report to a STA about a second AP, according to one embodiment.

FIG. 3 depicts a flowchart of an exemplary method for a first AP providing an updated report to a STA about a second AP, according to one embodiment.

FIG. 4 depicts a diagram of an example network with an AP and multiple neighbor APs, according to one embodiment.

FIG. 5 an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories, and one or more processors communicatively coupled to the one or more memories, with the one or more processors configured to, individually or collectively, perform operations. The operations include receiving, from a neighbor AP, a BSSID for the neighbor AP and a remaining time until the neighbor AP rotates the BSSID. The operations further include transmitting a report to a STA associated with the AP, which includes the BSSID for the neighbor AP and the remaining time until the neighbor AP rotates the BSSID.

One embodiment presented in this disclosure is a STA that includes one or more memories, and one or more processors communicatively coupled to the one or more memories, with the one or more processors configured to, individually or collectively, perform operations. The operations include transmitting, to an AP, report of parameters for a neighbor AP, wherein the STA is associated with the AP. The operations further include receiving, from the AP, the report, which includes a BSSID for the neighbor AP and a remaining time until the neighbor AP rotates the BSSID.

### EXAMPLE EMBODIMENTS

The present disclosure describes an AP that provides, to an associated STA, information for neighboring APs when the STA plans to connect to another AP (e.g., roaming to another AP). A STA may associate with a first AP to gain access to a network. When the STA physically moves locations or roams, the STA may attempt to associate with a second, nearer AP. However, the STA may fail to discover the second AP if the second AP changes parameters. The second AP may change parameters (e.g., an SSID or BSSID) to prevent a malicious device or user from mimicking the second AP. As an example, if the second AP changes the BSSID, the STA may fail to discover the second AP because the STA would be searching for an old BSSID of the second AP when the STA attempts to associate with the second AP.

To assist the STA, the first AP may transmit a report, such as a Reduced Neighbor Report (RNR), to indicate information about neighboring APs, such as the second AP. The information in the report may include a BSSID for each neighbor AP and a remaining time until each neighbor AP rotates the BSSID. Using this information, the STA may determine the current BSSID of the second AP and how long the STA has to associate with the second AP using the current BSSID.

If the STA does not have enough time to associate with the second AP before the BSSID changes or if the STA fails to discover the second AP when the STA is roaming, the STA may request more information about the second AP. The first AP may provide the STA with a future BSSID of the second AP that the STA may use to associate with the second AP.

In some embodiments, the system provides several technical advantages. For example, the report of neighboring APs may provide the STA information about other APs. This information allows the STA to continuously stay connected to the network as the STA roams from one AP to another AP. Additionally, the report may provide future information about neighboring APs, which may improve the chances that the STA discovers another AP.

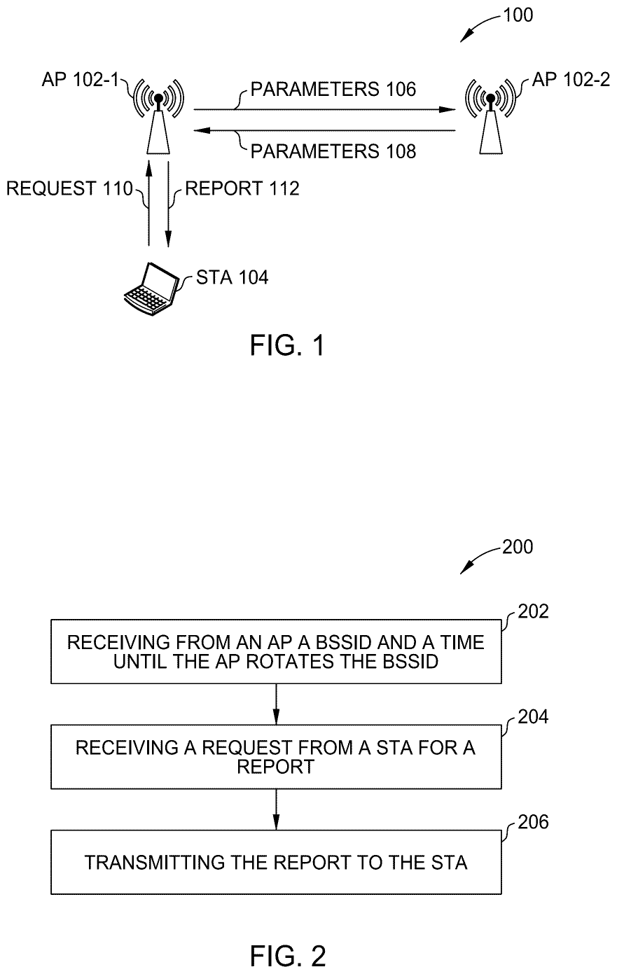

FIG. 1 depicts a system 100 that includes an AP 102-1, an AP 102-2, and a STA 104. The APs 102-1 and 102-2 may be part of the same network, which includes other APs. The STA 104 may associate with the AP 102-1 to gain access to a network. The other APs in the network may be neighbor APs of the AP 102-1 (e.g., the AP 102-2). Similarly, the other APs in the network may be neighbor APs of the AP 102-2 (e.g., the AP 102-1). An AP in the network may transmit information to neighbor APs about parameters of the AP. For example, the AP 102-1 may transmit information about parameters of the AP 102-1 (e.g., a BSSID of the AP 102-1) to the AP 102-2 using a signal 106. Similarly, the AP 102-2 may transmit information about parameters of the AP 102-2 (e.g., a BSSID of the AP 102-1) to the AP 102-2 using a signal 108. Other parameters that the APs in the network may transmit include, but are not limited to, a duration until the AP rotates a current BSSID, media access control (MAC) rotation algorithm type of the AP, current MAC address of the AP, and duration that the AP has been using the current BSSID. Each of the APs in the network may receive different parameters from the neighbor APs. The APs 102-1 and 102-2 may transmit information based on a configured time interval. The APs 102-1 and 102-2 may change parameters (e.g., an SSID or BSSID) to prevent a malicious device or user from mimicking the APs 102-1 or 102-2. Because the APs 102-1 and 102-2 may be periodically transmitting parameters to each other based on the configured time interval, the APs 102-1 and 102-2 may have updated parameters of the other AP. The APs 102-1 and 102-2 may also transmit the parameters to an associated STA.

In one embodiment, before the STA 104 physically moves locations or roams, the STA 104 requests a report (e.g., an RNR) from the AP 102-1 indicating parameters for the neighboring APs (e.g., the AP 102-2) using a signal 110. The AP 102-1 may respond to the request by transmitting the report to the STA 104 using a signal 112. The report may include information about one, some, or each of the neighboring APs of the AP 102-1. The information in the report may include a BSSID for each neighbor AP (e.g., the BSSID of the AP 102-2) and a remaining time until each neighbor AP rotates the BSSID. The BSSID may include any combination of numbers, letters, or symbols. Using this information, the STA 104 may determine current BSSIDs of the neighboring APs and how long the STA 104 has to associate with the neighboring APs using the current BSSIDs. In some embodiments, the AP 102-1 sends the report, unsolicited, to the STA 104. For example, the AP 102-1 may transmit the unsolicited report to the STA 104 after a configurable amount of time or after the AP 102-1 receives updated parameters from a neighboring AP.

When the STA 104 physically moves location or roams, the STA 104 may scan for a new AP (e.g., the AP 102-2). If the AP 102-2 has changed or rotated the BSSID of the AP 102-2, however, the STA 104 may fail to discover the AP 102-2 because the STA 104 would be searching for an old BSSID of the AP 102-2 when the STA 104 attempts to associate with the AP 102-2. The STA 104 may fail to discover the AP 102-2 due to clock drifts between the AP 102-2 and the STA 104. The AP 102-2 may have already changed to a new BSSID, but a clock for the STA 104 still expects the old BSSID.

In one embodiment, the STA 104 transmits a signal requesting an updated report for a target AP (e.g., the AP 102-2). Because the APs 102-1 and 102-2 are transmitting updated parameters with each other based on the configured time interval, in one embodiment, the AP 102-1 transmits the updated report to the STA 104 without requesting updated parameters from the AP 102-2. In one embodiment, the AP 102-1 transmits a request for updated parameters from the AP 102-2 before transmitting the updated report to the STA 104. The updated report may include updated parameters for the AP 102-2 such as a current BSSID of the AP 102-2 and how long the STA 104 has to associate with the AP 102-2 using the current BSSID. The update report may include more parameters than the report to the STA 104 such as a MAC rotation algorithm type of the AP 102-2, current MAC address of the AP 102-2, and duration that the AP 102-2 has been using the current BSSID. Based on the updated parameters, the AP 102-1 may determine a future BSSID of the AP 102-2 at a future time. The AP 102-1 may provide in the updated report the future BSSID of the AP 102-2 such that the STA 104 may use the future BSSID to associate with the AP 102-2. Using the updated report, the STA 104 may associate with the AP 102-2 and disassociate from the AP 102-1.

In one embodiment, if the STA 104 does not have enough time to associate to the AP 102-2 before the BSSID changes, the STA 104 may request the AP 102-1 for the updated report before physically moving location or roaming. By providing the updated report before the STA 104 physically moves locations or roams, the STA 104 may be more likely to associate with the AP 102-2. In one embodiment, the STA 104 requests for the updated report to be based on a target time when the STA 104 plans to move location or roam. The target time may be based on a clock of the AP 102-1. As mentioned before, the AP 102-1 may determine parameters for the neighboring APs (e.g., the AP 102-2) using the parameters that each neighboring AP transmits based on the configured time interval.

FIG. 2 depicts a flowchart of an exemplary method 200 for a first AP (such as the AP 102-1 in FIG. 1) providing a report to a STA (such as the STA 104 in FIG. 1) about a second AP (such as the AP 102-2 in FIG. 1). The first AP and the second AP may be one of multiple APs in a network. The other APs in the network (e.g., the second AP) may be neighbor APs of the first AP. Similarly, the other APs in the network (e.g., first AP) may be neighbor APs of the second AP. Each of the APs may transmit parameters of the AP to neighbor APs in the network. The parameters may be, but are not limited to, BSSID of the AP, a remaining time until the AP rotates the BSSID, a MAC rotation algorithm type of the AP, a current MAC address of the AP, and a duration that the AP has been using the current BSSID. In an exemplary embodiment, at block 202, the first AP receives a BSSID of the second AP and a time until the second AP rotates the BSSID of the second AP. The first AP may automatically receive parameters from the second AP after a configurable amount of time.

The STA may associate with one of the APs in the network (e.g., the first or second AP) to access the network. In one embodiment, the STA is associated with the first AP. The STA may want to move locations or start roaming while maintaining connection with the network. At block 204, the first AP receives a request for a report from the STA. The report may include some or all the parameters of the neighbor APs mentioned above. In one embodiment, the report includes a BSSID for each neighbor AP (e.g., the second AP) and a remaining time until each neighbor AP rotates the BSSID.

At block 206, the first AP transmits the report to the STA. In one embodiment, the STA uses the report to determine a current BSSID of the second AP and how long the STA has to associate with the second AP using the current BSSID. Using the current BSSID, the STA may associate with the second AP and disassociate from the first AP.

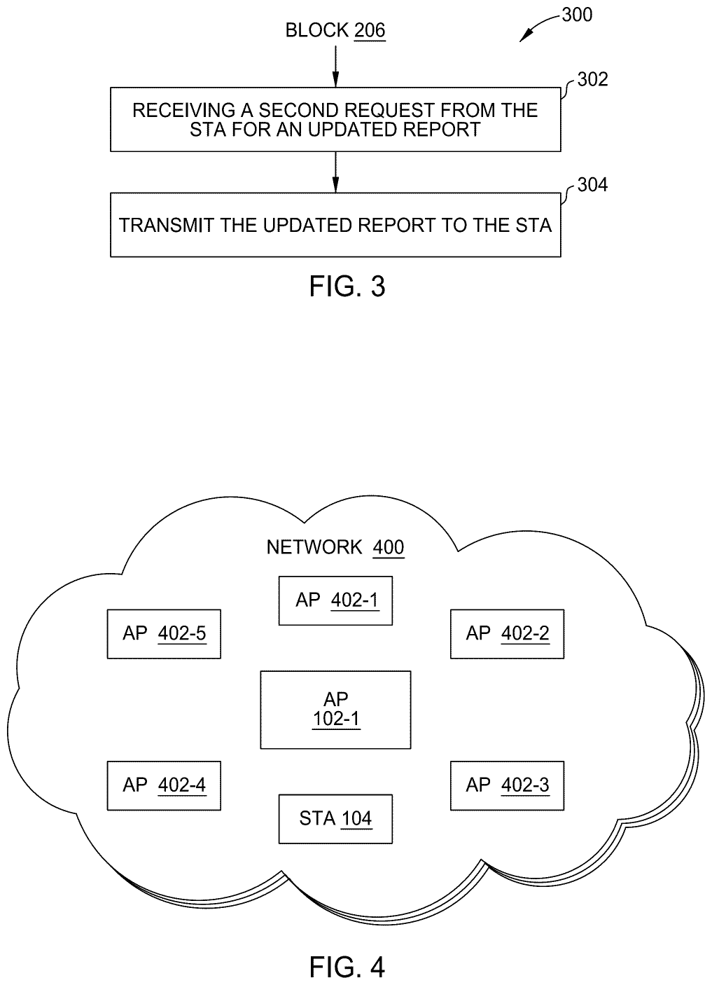

FIG. 3 depicts a flowchart of an exemplary method 300 for a first AP (such as the APs 102-1 in FIG. 1) providing an updated report to a STA (such as the STA 104 in FIG. 1) about a second AP (such as the APs 102-2 in FIG. 1) in a network. After the STA receives an initial report from the first AP (such as the report in block 206 of FIG. 2), the STA may attempt to associate with the second AP. The second AP, however, may have rotated the BSSID of the second AP since the STA received the report from the first AP. As a result, the STA may fail to discover the second AP because the STA is searching for an old BSSID of the second AP. To receive an updated BSSID, the STA may request an updated report from the first AP. At block 302, the first AP receives a second request from the STA for an updated report. In one embodiment, unlike the initial report, the updated report includes parameters for a target AP amongst the neighbor APs. In one embodiment, the updated report includes updated parameters for the second AP. The updated parameters may include an updated BSSID of the second AP, a remaining time until the second AP rotates the updated BSSID, a MAC rotation algorithm type of the second AP, current MAC address of the second AP, and a duration that the second AP has been using the updated BSSID.

At block 304, the first AP transmits the updated report to the STA. The STA may use the updated report to associate with the second AP. In one embodiment, the STA associates with the second AP using the updated parameters in the updated report and dissociates from the first AP.

FIG. 4 depicts a diagram of an example network 400 with the AP 102-1 and APs 402-1 through 402-5. The AP 102-1 may be associated with the STA 104. The network 400 may include other APs beyond the AP 102-1 and APs 402-1 through 402-5. Each of the APs 402-1 through 402-5 may be neighbor APs of the AP 102-1. Similarly, the APs 402-2 through 402-5 and AP 102-1 may be neighbor APs of the AP 402-1, and so on. An AP in the network 400 may transmit information about parameters of an AP to neighbor APs. For example, the AP 102-1 may transmit information about parameters of the AP 102-1 to each of the APs 402-1 through 402-5. In one embodiment, the AP 102-1 receives parameters for each of the APs 402-1 through 402-5. The parameters may include, but are not limited to, a current BSSID for each of the APs 402-1 through 402-5, how long until each of the APs 402-1 through 402-5 rotates the current BSSID, a MAC rotation algorithm type of each of the APs 402-1 through 402-5, a current MAC address of each of the APs 402-1 through 402-5, and a duration that each of the APs 402-1 through 402-5 has been using the current BSSID. The APs 102-1 and 402-1 through 402-5 may automatically transmit updated parameters to neighbor APs based on a configured time interval. Each of the parameters may be relative to a timing synchronization function (TSF) in the AP 102-1 or 402-1 through 402-5. In one embodiment, each of the APs 102-1 and 402-1 through 402-5 has a different TSF. Because each of the APs may have a different TSF, the parameters transmitted to the neighbor APs may have a timestamp relative to a different clock. The AP may use the timestamp to determine an offset from a clock on one of the neighbor APs.

In one embodiment, before the STA 104 physically moves locations or roams, the STA 104 requests a report (e.g., an RNR) from the AP 102-1 indicating parameters for the neighboring APs (e.g., the APs 402-1 through 402-5). The AP 102-1 may respond to the request by transmitting the report to the STA 104. The report may include information about one, some, or each of the neighboring APs. The information in the report may include a BSSID for each neighbor AP and a remaining time until each neighbor AP rotates the BSSID. The BSSID may include any combination of numbers, letters, or symbols. The STA 104 may determine, in one embodiment, a current BSSID of the AP 402-1 and how long the STA 104 has to associate with the AP 402-1 using the current BSSID. In some embodiments, the AP 102-1 sends the report, unsolicited, to the STA 104. For example, the AP 102-1 may transmit the unsolicited report to the STA 104 after a configurable amount of time or after the AP 102-1 receives updated parameters from a neighboring AP.

When the STA 104 physically moves location or roams, the STA 104 may scan for a new AP (e.g., the AP 402-1). If the AP 402-1 has changed or rotated the BSSID of the AP 402-1, however, the STA 104 may fail to discover the AP 402-1 because the STA 104 would be searching for an old BSSID of the AP 402-1 when the STA 104 attempts to associate with the AP 402-1. This scenario may occur due to an offset between TSFs between the AP 102-1 and the AP 402-1. The AP 102-1 may resolve this potential difference between TSFs by determining the current BSSID of the AP 402-1 and how long the STA 104 has to associate with the AP 402-1 using the current BSSID before the AP 402-1 rotates the current BSSID relative to the difference between TSFs. By factoring in the difference between TSFs, the STA 104 may have a better chance at associating with the AP 402-1. A STA 104 may have a better chance at associating with the AP 402-1 if the APs 102-1 and 402-1 through 402-5 have time-synced TSFs. In an embodiment where the APs 102-1 and 402-1 through 402-5 have time-synced TSFs, when the AP 102-1 transmits information to the STA 104, the STA 104 may know that the information is in-sync with the timing of the APs 402-1 through 402-5.

In one embodiment, the STA 104 transmits a signal requesting an updated report for a target AP (e.g., the AP 402-1) with which the STA attempted to associate. The request from the STA 104 may include a request for a timestamp for when the target AP may rotate to a new BSSID. In one embodiment, the timestamp is relative to a TSF of the target AP. Because the APs 102-1 and 402-1 through 402-5 are transmitting updated parameters based on the configured time interval, in one embodiment, the AP 102-1 may transmit the updated report to the STA 104 without requesting updated parameters from the AP 402-1. In one embodiment, the AP 102-1 transmits a request for updated parameters from the AP 402-1 before transmitting the updated report to the STA 104. The updated report may include updated parameters for the AP 402-1 such as a current BSSID of the AP 402-1 and how long the STA 104 has to associate with the AP 402-1 using the current BSSID. The update report may include more parameters such as a MAC rotation algorithm type of the AP 402-1, current MAC address of the AP 402-1, duration that the AP 402-1 has been using the current BSSID, and a difference between the TSF of the AP 102-1 and the TSF of the AP 402-1.

Based on the updated parameters, the AP 102-1 may determine a future BSSID of the AP 402-1 at a future time. The AP 102-1 may provide in the updated report the future BSSID of the AP 402-1 such that the STA 104 may use the future BSSID to associate with the AP 402-1. Using the updated report, the STA 104 may associate with the AP 402-1 and disassociate from the AP 102-1. In one embodiment, if the STA 104 does not have enough time to associate to the AP 402-1 before the BSSID changes, the STA 104 may request the AP 102-1 for the updated report prior physically moving location or roaming. By providing the updated report before the STA 104 physically moves location or roams, the STA 104 is more likely to associate with the AP 402-1. In one embodiment, the STA 104 requests for the updated report to be based on a target time when the STA 104 plans to move location or roam. The target time may be based on a clock of the AP 102-1. As mentioned before, the AP 102-1 may determine parameters for the neighboring APs (e.g., the AP 402-1 through 402-5) using the updated parameters that each neighboring AP may transmit based on the configured time interval. The STA 104 may use parameters of the updated report to pre-determine values for associating with the AP 402-1. For example, the STA 104 may start pre-computing elements of a 4-way handshake based on the future BSSID value of the AP 402-1 and begin exchanging frames with the AP before roaming.

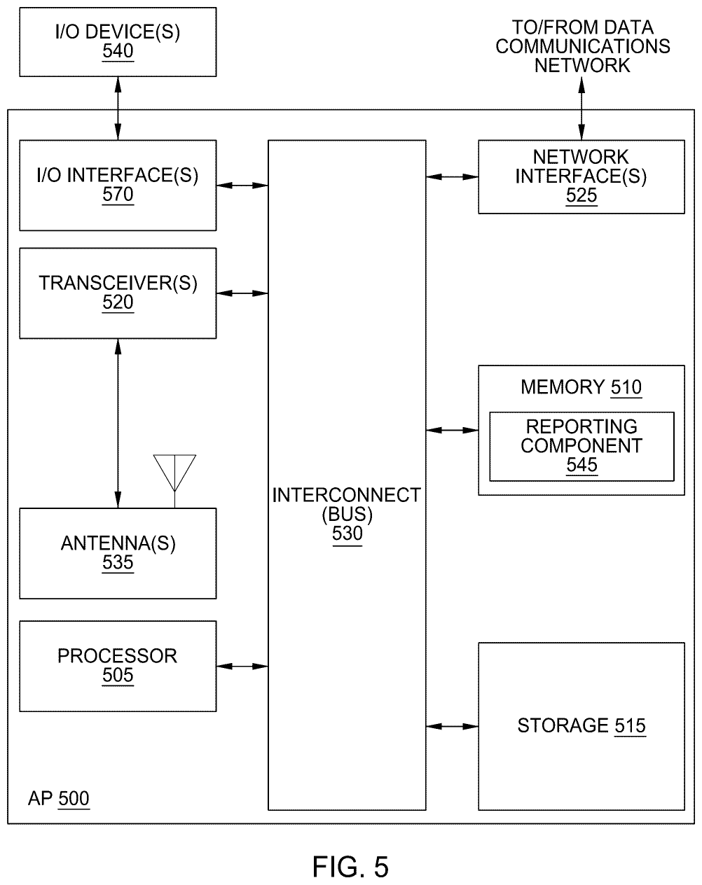

FIG. 5 depicts an example network device 500 configured to perform various aspects of the present disclosure, according to some aspects of the present disclosure. The network device 500 may be an AP, which corresponds to the APs 108-1 through 108-4 as depicted in FIG. 1.

As illustrated, the example network device 500 includes a processor 505, memory 510, storage 515, one or more transceivers 520, one or more I/O interfaces 580, and one or more network interfaces 525. In some embodiments, I/O devices 540 are connected via the I/O interface(s) 580. Further, via the network interface 525, the network device 500 can be communicatively coupled with one or more other devices and components (e.g., via a network, which may include the Internet, local network(s), and the like). Each of the components is communicatively coupled by one or more buses 530. In some embodiments, one or more antennas 535 may be coupled to the transceivers 520 for transmitting and receiving wireless signals.

The processor 505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 505 processes information received through the transceiver 520, I/O interfaces 580, and the network interfaces 525. The processor 505 retrieves and executes programming instructions stored in memory 510, as well as stores and retrieves application data residing in storage 515.

The storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 515 may store a variety of data for the efficient functioning of the system.

The memory 510 may include random access memory (RAM) and read-only memory (ROM). The memory 510 may store processor-executable software code containing instructions that, when executed by the processor 505, enable the network device 500 to perform various functions described herein for wireless communication. In the illustrated example, the memory 510 includes a software component: reporting component 545.

In one embodiment, the reporting component 545 is configured gather information of parameters for neighboring APs (e.g., the APs 402-1 through 402-5 in FIG. 4). More specifically, the reporting component 545 includes each report for the neighbor APs such that the information can be transmitted to an associated STA.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP) comprising:
one or more memories; and
one or more processors communicatively coupled to the one or more memories, wherein the one or more processors are configured to, individually or collectively, perform operations comprising:
receiving, from a neighbor AP, a basic service set identifier (BSSID) for the neighbor AP and a remaining time until the neighbor AP rotates the BSSID; and
transmitting a report to a station (STA) associated with the AP, wherein the report comprises the BSSID for the neighbor AP and the remaining time until the neighbor AP rotates the BSSID.

2. The AP of claim 1, wherein the operations further comprise:
receiving, from the neighbor AP, a media access control (MAC) rotation algorithm type of the neighbor AP, a current MAC address of the neighbor AP, and a duration that the neighbor AP has been using the BSSID; and
determining, using the MAC rotation algorithm type, the current MAC address, and the duration, a future BSSID for the neighbor AP and a future time when the neighbor AP will rotate to the future BSSID, wherein the report comprises the future BSSID and the future time when the neighbor AP will rotate to the future BSSID.

3. The AP of claim 2, wherein the future time when the neighbor AP will rotate to the future BSSID is based on a timing synchronization function of the AP.

4. The AP of claim 1, wherein the operations further comprise prior to transmitting the report to the STA, receiving a request from the STA for the report, wherein the report comprises BSSIDs for a plurality of neighbor APs, MAC addresses of the plurality of neighbor APs, and remaining times for the plurality of neighbor APs, wherein the remaining times for the plurality of neighbor APs are times until the plurality of neighbor APs rotates the BSSIDs for the plurality of neighbor APs, wherein the neighbor AP is one of the plurality of neighbor APs.

5. The AP of claim 4, wherein the BSSID for the neighbor AP and the remaining time until the neighbor AP rotates the BSSID for the neighbor AP are different from a BSSID and a remaining time for at least one of the plurality of neighbor APs.

6. The AP of claim 4, wherein the operations further comprise:
responsive to the STA failing to associate with the neighbor AP, receiving a second request from the STA for an updated report comprising an updated BSSID and an updated remaining time until the neighbor AP rotates the updated BSSID; and
transmitting the updated report to the STA.

7. The AP of claim 6, wherein the second request comprises a request for a timestamp for when the neighbor AP will rotate to the updated BSSID, wherein the timestamp is in terms of a timing synchronization function of the neighbor AP, and wherein the updated report comprises a difference between a timing synchronization function of the AP and the timing synchronization function of the neighbor AP.

8. A method comprising:
receiving, by an access point (AP), from a neighbor AP, a basic service set identifier (BSSID) for the neighbor AP and a remaining time until the neighbor AP rotates the BSSID; and
transmitting a report to a station (STA) associated with the AP, wherein the report comprises the BSSID for the neighbor AP and the remaining time until the neighbor AP rotates the BSSID.

9. The method of claim 8, further comprises:
receiving, from the neighbor AP, a media access control (MAC) rotation algorithm type of the neighbor AP, a current MAC address of the neighbor AP, and a duration that the neighbor AP has been using the BSSID; and
determining, using the MAC rotation algorithm type, the current MAC address, and the duration, a future BSSID for the neighbor AP and a future time when the neighbor AP will rotate to the future BSSID, wherein the report comprises the future BSSID and the future time when the neighbor AP will rotate to the future BSSID.

10. The method of claim 9, wherein the future time when the neighbor AP will rotate to the future BSSID is based on a timing synchronization function of the AP.

11. The method of claim 8, further comprising prior to transmitting the report to the STA, receiving a request from the STA for the report, wherein the report comprises BSSIDs for a plurality of neighbor APs, MAC addresses of the plurality of neighbor APs, and remaining times for the plurality of neighbor APs, wherein the remaining times for the plurality of neighbor APs are times until the plurality of neighbor APs rotates the BSSIDs for the plurality of neighbor APs, wherein the neighbor AP is one of the plurality of neighbor APs.

12. The method of claim 11, wherein the BSSID for the neighbor AP and the remaining time until the neighbor AP rotates the BSSID for the neighbor AP are different from a BSSID and a remaining time for at least one of the plurality of neighbor APs.

13. The method of claim 11, further comprising:
responsive to the STA failing to associate with the neighbor AP, receiving a second request from the STA for an updated report comprising an updated BSSID and an updated remaining time until the neighbor AP rotates the updated BSSID; and
transmitting the updated report to the STA.

14. The method of claim 13, wherein the second request comprises a request for a timestamp for when the neighbor AP will rotate to the updated BSSID, wherein the timestamp is in terms of a timing synchronization function of the neighbor AP, and wherein the updated report comprises a difference between a timing synchronization function of the AP and the timing synchronization function of the neighbor AP.

15. A station (STA) comprising:
one or more memories; and
one or more processors communicatively coupled to the one or more memories, wherein the one or more processors are configured to, individually or collectively, perform operations comprising:
transmitting, to an access point (AP), report of parameters for a neighbor AP, wherein the STA is associated with the AP; and
receiving, from the AP, the report, wherein the report comprises a BSSID for the neighbor AP and a remaining time until the neighbor AP rotates the BSSID.

16. The STA of claim 15, wherein the report comprises BSSIDs for a plurality of neighbor APs, MAC addresses of the plurality of neighbor APs, and remaining times for the plurality of neighbor APs, wherein the remaining times are times until the plurality of neighbor APs rotates the BSSIDs for the plurality of neighbor APs, wherein the neighbor AP is one of the plurality of neighbor APs.

17. The STA of claim 16, wherein the BSSID for the neighbor AP and the remaining time until the neighbor AP rotates the BSSID for the neighbor AP are different from a BSSID and a remaining time for at least one of the plurality of neighbor APs.

18. The STA of claim 16, wherein the operations further comprise:
responsive to failing to associate with the neighbor AP, transmitting a second request to the AP for an updated report comprising an updated BSSID and an updated remaining time until the neighbor AP rotates the updated BSSID; and
receiving the updated report.

19. The STA of claim 18, wherein the second request comprises a request for a timestamp for when the neighbor AP will rotate to the updated BSSID, wherein the timestamp is in terms of a timing synchronization function of the neighbor AP, and wherein the updated report comprises a difference between a timing synchronization function of the AP and the timing synchronization function of the neighbor AP.

20. The STA of claim 18, wherein the operations further comprise prior to associating with the neighbor AP, determining values for associating with the neighbor AP based on the updated BSSID.
